(19) United States
(12) Patent Application Publication
(10) Pub. No.: US 2013/0325494 A1
(43) Pub. Date: Dec. 5, 2013

(54) Mobile Fulfillment Platform For Prescription Medications

(71) Applicant: Luis Angel, Valencia (ES)

(72) Inventor: Luis Angel, Valencia (ES)

(73) Assignee: GETMYRX LLC, Miami, FL (US)

(21) Appl. No.: 13/904,961

(22) Filed: May 29, 2013

Related U.S. Application Data
(60) Provisional application No. 61/652,856, filed on May 30, 2012.

(51) Int. Cl. G06Q 30/00

(52) U.S. Cl. CPC G06Q 30/00
USPC 705/2

(57) ABSTRACT

Embodiments are directed towards a method implemented by a server computer for electronic ordering of medicine by a patient from a pharmacy after a valid paper or electronic prescription has been issued by a doctor, including maintaining a database of doctors that includes records for doctors, the records including a point-of-care location where a doctor provides care to patients, receiving from a mobile device a location of the mobile device at a designated time, determining that the location of the mobile device at the designated time matches a point-of-care location for a doctor included in the database of doctors, inferring that the user of the mobile device has visited the doctor, and sending an alert message to the mobile device.

### REFERENCE TO RELATED APPLICATIONS

This application claims benefit of U.S. Provisional Application No. 61/652,856, entitled “METHOD FOR ELECTRONIC CONFIRMATION, ORDERING AND PURCHASE OF ELECTRONIC PRESCRIPTIONS”, filed on May 30, 2012 by inventor Luis Angel.

### BACKGROUND

The invention relates to a mobile application for mobile devices capable of (i) inferring if a user has visited a doctor or physician, (ii) alerting the user after the doctor's visit to an opportunity to order a prescription medicine electronically using their mobile device in case the doctor has provided a paper or electronic prescription and (iii) enabling the user to order the medicine from a local community pharmacy nearby.

This is important because a large percentage of doctor visits result in a new prescription being written to the patient. Of these new prescriptions, approximately 30 percent go unfilled by the patient for a variety of reasons. Further, studies have shown that the probability of a prescription being filled is highest at point-of-care, i.e. in the doctor's office, and drops over time.

Thus there is an opportunity to enable users to use their mobile devices to order prescriptions electronically either while they are at the doctor's office, or shortly afterwards.

Thus, it is with respect to these considerations and others that the present invention has been made.

### SUMMARY OF THE DESCRIPTION

Various embodiments are directed towards a mobile application for smartphone devices that reports its location to a central server computer which uses a database of prescribing doctors to infer whether a user has has visited a doctor. If a doctor's visit is inferred, the server sends an alert message to the user that enables the user to open the mobile application which enables the user to electronically place an order for the prescription medications from a local community pharmacy.

One objective of the subject invention is to issue an alert message just after the user completes a doctor's visit. The system uses the location of the user's mobile device together with information maintained in a prescriber database to infer when a doctor's visit has occurred. In one embodiment, the invention estimates the length of a typical doctor's visit and infers that a doctor's visit has occurred if the user remains within point-of-care range, which is an area that includes the point-of-care location where the doctor provides care to patients, for the duration of the estimated time of a doctor's visit. In another embodiment, a doctor's visit is inferred if the user remains within the point-of-care range for a designated period of time.

Embodiments are directed towards a method implemented by a server computer for electronic ordering of prescription medicine, including maintaining a database of doctors that includes records for doctors, the records including a point-of-care location where a doctor provides care to patients, receiving from a mobile device a location of the mobile device at a designated time, determining that the location of the mobile device at the designated time matches a point-of-care location for a doctor included in the database of doctors, inferring that the user of the mobile device has visited the doctor, and sending an alert message to the mobile device.

Other embodiments are directed toward a server computer, that includes a processor, a network interface card in communication with the processor, a data storage for maintaining a database of doctors that includes records for doctors, the records including a point-of-care location where a doctor provides care to patients, and a memory in communication with the processor for storing instructions, which when executed by the processor, cause the server, to receive from a mobile device a location of the mobile device at a designated time, to determine that the location of the mobile device at the designated time matches a point-of-care location for a doctor included in the database of doctors, to infer that the user of the mobile device has visited the doctor, and to send an alert message to the mobile device.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 is a generalized block diagram of a preferred embodiment of a mobile fulfillment platform for prescription medications that enables a user to receive a mobile alert and electronically send an order for a prescription to a pharmacy.

FIG. 2A illustrates one embodiment of a user interface of a mobile application that alerts a user and asks if he/she wants to place an order for a prescription electronically.

FIG. 2B illustrates one embodiment of a user interface of a mobile application that enables a user to place an order for prescription medicine from a pharmacy.

FIGS. 3A-B provide an overall flowchart of the steps performed by a central server and a mobile application to enable a user to use a mobile application to electronically place an order for a prescription from a pharmacy.

FIGS. 4A-B are flowcharts of two embodiments of a method for inferring a visit by a user to a doctor.

FIG. 5 is a system diagram that shows components of one exemplary environment in which the invention may be practiced.

FIG. 6 is a block diagram of the exemplary software modules of a central server used in a mobile fulfillment system for prescription medications.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Prescription—a written or electronic document provided by a doctor that establishes the right of a patient, also referred to herein as a user, to purchase specified drugs or medicine. More generally, a prescription may refer also to services, such as physical therapy, and recommended products and services.

Doctor—a physician or medical doctor or other healthcare provider that can write a prescription for medicine or drugs.

Pharmacy—refers to a physical location where prescriptions are fulfilled.

### Generalized Operation

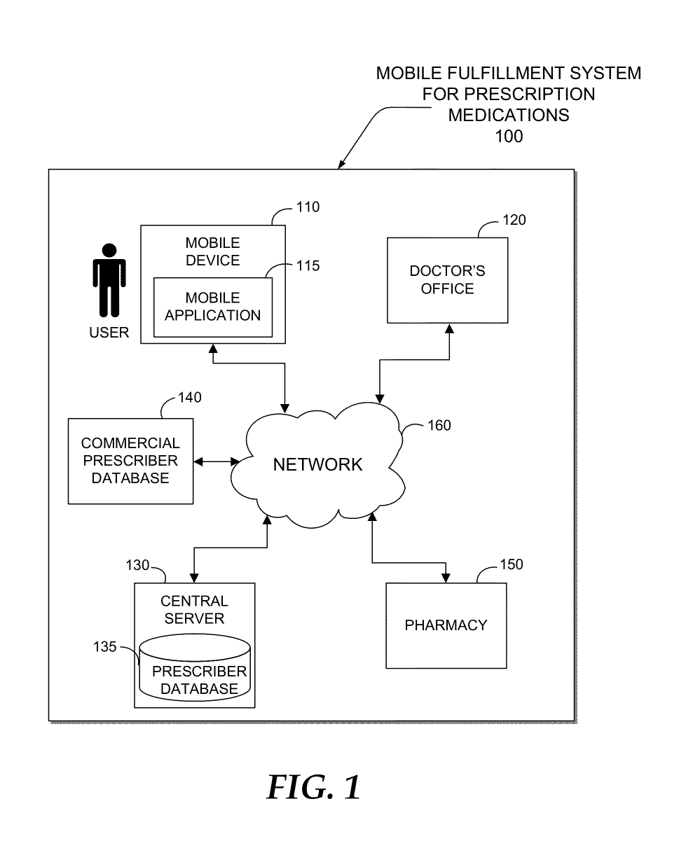

The operation of certain aspects of the invention is described below with respect to FIGS. 1-6.

FIG. 1 is a generalized block diagram of a preferred embodiment of a mobile fulfillment platform for prescription medications 100 that enables a user to receive a mobile alert and electronically send an order for a prescription to a pharmacy. A patient, hereinafter referred to simply as a user, uses a mobile application 115 that runs in the user's mobile device 110 to perform some or all of the following functions: receive alerts, identify preferred doctors and pharmacies, and order prescription medicine. In the discussion below it is assumed that a single mobile device 110 is used by a single user; although it may be appreciated by one skilled in the art that user authentication, such as provided by username/password, may enable a single mobile device 110 to be used by more than one user. Thus, in other embodiments mobile application 115 may serve more than one user.

In operation, a user, in possession of mobile device 110, visits a doctor's office 120. Mobile device 110 periodically transmits its geographic location to a central server 130. Central server 130 monitors the user's physical location and at some point infers that the user has visited doctor's office 120. Central server 130 issues an alert to the user via mobile device 110. The user may respond to the alert by opening mobile application 115 and proceeding to place an order the prescription medicine from a pharmacy 150. Mobile application 115 enables a user to process a paper prescription, i.e. a paper form completed by a doctor, or an electronic prescription. The user can open and use mobile application 115 to place an order to fulfill or obtain a refill for a prescription at any time; i.e. a user doesn't have to wait to first receive an alert in order to use mobile application 115.

Central server 130 obtains a variety of information about doctors from a commercial prescriber database 140 that is available across a network 160 such as the Internet. In one embodiment, central server 130 periodically accesses commercial prescriber database 140 and extracts selected information and creates and maintains its own private prescriber database 135.

Prescriber database 140 refers to a service that is available across a network 160. There are several such commercially available services. One such service is located on the Web at http://www.healthcaredatasolutions.com/, and is operated by Healthcare Data Solutions. Each such commercial service may provide different formats and data. It may further be appreciated that commercial prescriber database 140 may refer to a privately owned and maintained database, such as a database kept by a hospital, that is not made commercially available. Thus, the name “commercial prescriber database” is meant mainly to delineate its role relative to prescriber database 135 which is maintained by central server 130 and is not intended to limit the function or structure of commercial prescriber database 140 in any way. An example, of the data stored in prescriber database 135 is given below in Table 1.

TABLE 1
Example Prescriber Database 135

| Field | Description |
|---|---|
| UID | Unique code for doctor |
| POC_Code | Code for doctor's point of care location |
| First_Name | Doctor's first name |
| Middle_Name | Doctor's middle name |
| Last_Name | Doctor's last name |
| Specialty | Doctor's specialty |
| Company | Doctor's company |
| Address | Street address of point-of-care (POC) location |
| City | City of POC location |
| State | State of POC location |
| Zip | Zip of POC location |
| LAT | Latitude of POC |
| LONG | Longitude of POC location |
| Num_Employees | Number of employees at POC location |

Pharmacy 150 is a pharmacy that accepts an electronic order placed by central server 130 across network 160.

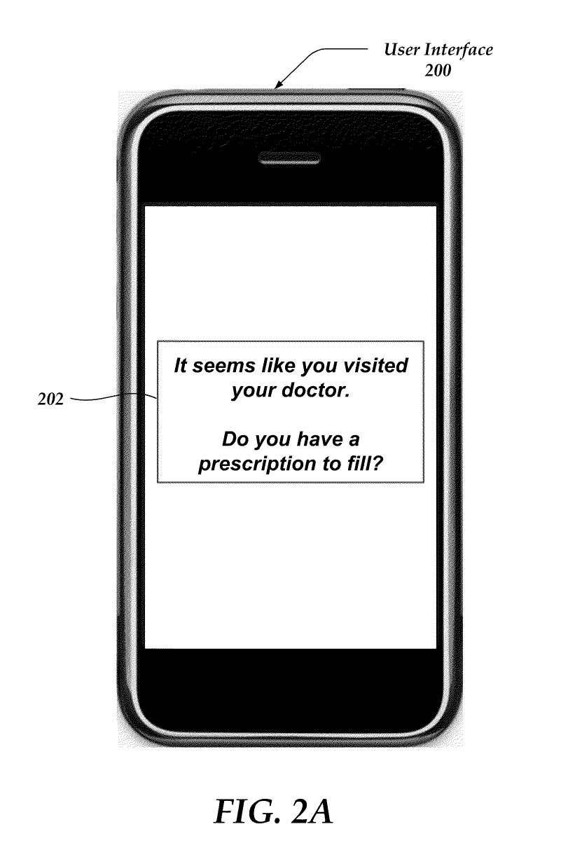

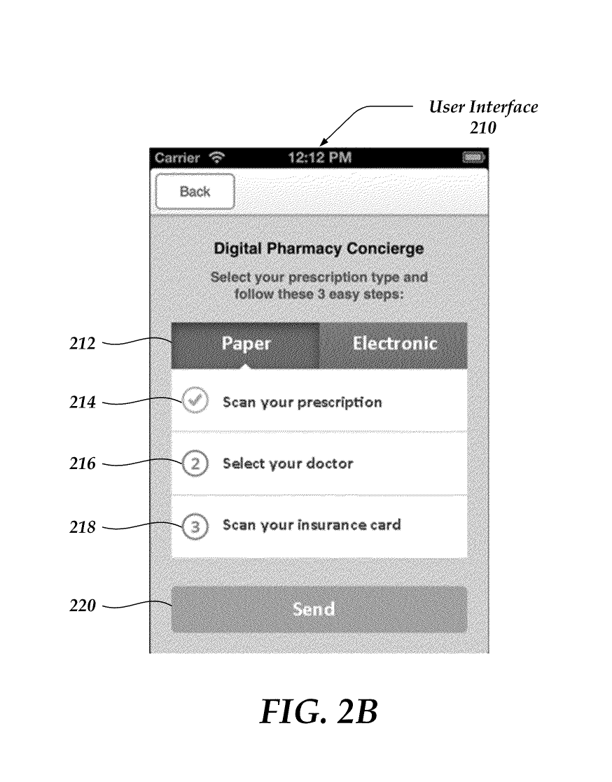

FIGS. 2A-B are embodiments of a user interface provided by mobile application 115. In certain embodiments, the user interfaces of FIGS. 2A-2B are provided by a mobile application that runs under a mobile operating system. In other embodiments, the user interfaces of FIGS. 2A-2B correspond to interactive Web pages that run on mobile devices such as the IPHONE provided by Apple Computer, Inc.

FIG. 2A illustrates one embodiment of a user interface of a mobile application that alerts a user and asks if he/she wants to place an order for a prescription electronically. The user can then activate mobile application 115, for example by swiping across an alert message 202, which then presents a user interface such as that illustrated in FIG. 2B. Alternatively, the user may ignore the alert message. In that case there are several alternative behaviors that may be implemented by mobile application 115; for example, mobile application 115 may re-display alert message 202 after a period of time.

FIG. 2B illustrates one embodiment of a user interface 210 of a mobile application that enables a user to place an order for prescription medicine from a pharmacy. Typically, user interface 210 is activated by a user after he/she receives a prescription from a doctor. Using a control 212 the user indicates whether the prescription that he/she received is on paper or was made electronically. Using a control 214 the user can indicate that he/she has a paper prescription that he/she wants to scan in which case mobile application 115 enables the user to scan the paper prescription.

Using a control 216 the user can select the doctor, also referred to as “the prescribing doctor”, from a list of local prescribers that may have issued the prescription. In one embodiment, to display the list of local prescribers, mobile application 115 requests a list from central server 130 which searches prescription database 135 and provides the list of doctors.

Using a control 218 the user can scan his/her insurance card, which will be supplied to the pharmacy when ordering a prescription electronically.

When the user has completed the various operations associated with an electronic prescription he/she uses a control 220 to indicate, by clicking “Send”, that he/she is ready to place the order.

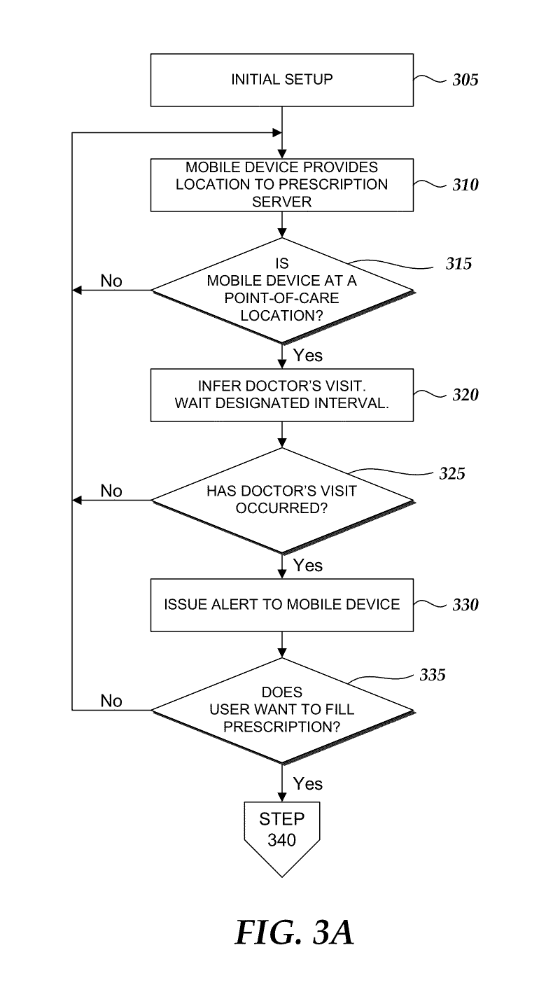

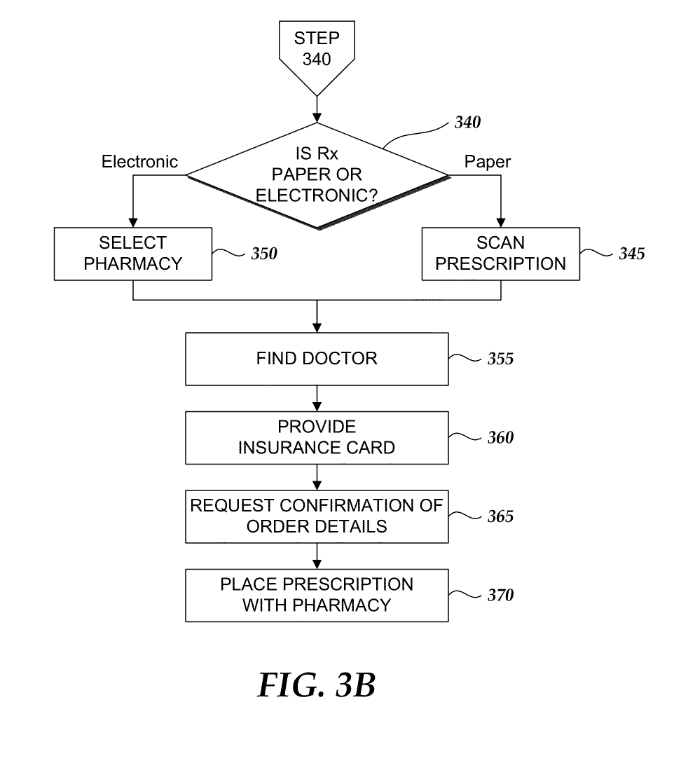

FIGS. 3A-B, and 4-6 are flowcharts and component diagrams in which each graphical element, including rectangles, cylinders, and triangles, can be implemented by computer program instructions. These program instructions may be provided to a processor and then executed by the processor, thus creating means for implementing the actions represented by the graphical element. The computer program instructions may be executed by a processor to cause a series of operational steps to be performed by the processor to produce a computer-implemented process such that the instructions, which execute on the processor to provide steps for implementing the actions represented by the graphical element. Some of the computer program instructions may be performed in parallel, or across more than one processor, such as might arise in a mufti-processor computer system. In addition, the actions represented by one or more graphical elements may also be performed concurrently with actions represented by other graphical elements, or even in a different sequence than illustrated without departing from the scope or spirit of the invention. It will also be understood that the actions represented by each graphical element and by combinations of graphical elements can be implemented by special purpose hardware-based systems that perform the specified actions or steps, or combinations of special purpose hardware and computer instructions.

FIGS. 3A-B provide an overall flowchart of the steps performed by the central server 130 and mobile application 115 to enable a user to electronically place an order for a prescription from a pharmacy. The method begins at step 305 with initial setup. Setup may include downloading mobile application 115 to mobile device 110 and setting up the application and its associated databases.

As part of setup, the user may be prompted to authorize the mobile application to track the location of mobile device 110 and to send it notifications and alerts. If the user declines to authorize location tracking then, in certain embodiments, the user is reminded to enable location tracking and alert services whenever the mobile application 115 is activated. If certain embodiments, alert services are disabled if the user declines to enable location tracking a designated number of times.

Prescriber database 135 may also include a subset of the fields available in records in commercial prescriber database 140 and may include additional fields not present in commercial prescriber database 140.

At step 310 mobile device 110 provides its location to central server 130. This step is performed periodically; for example, every 1-2 minutes, as indicated by the return loop from step 340.

Then, at step 315 central server 130 determines if mobile device 110 is at a point-of-care location, where a point-care-location is an office or work facility of a prescribing doctor. For example a point-of-care location may be a small office for a single doctor or for several doctors, a medium-sized clinic or a hospital. This step is performed by comparing the geographic coordinates for mobile device 110, as obtained in step 310, with the geographic coordinates of doctors' offices listed in any of (1) a preferred doctors list, (2) prescriber database 135, or (3) commercial prescriber database 140. If this step determines that the mobile device 110 is at or very near to a point-of-care location, for example within 100 meters, then processing flows to step 320. If not then processing returns to step 310.

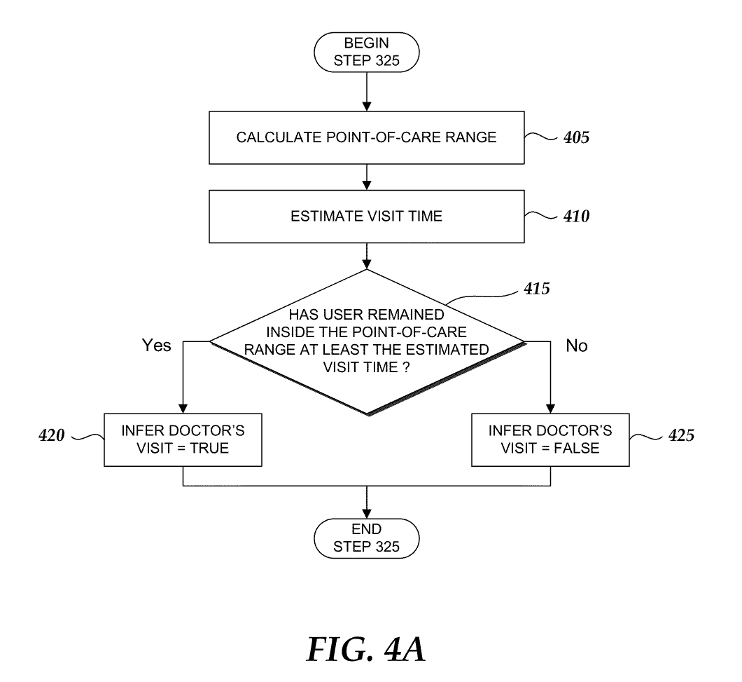

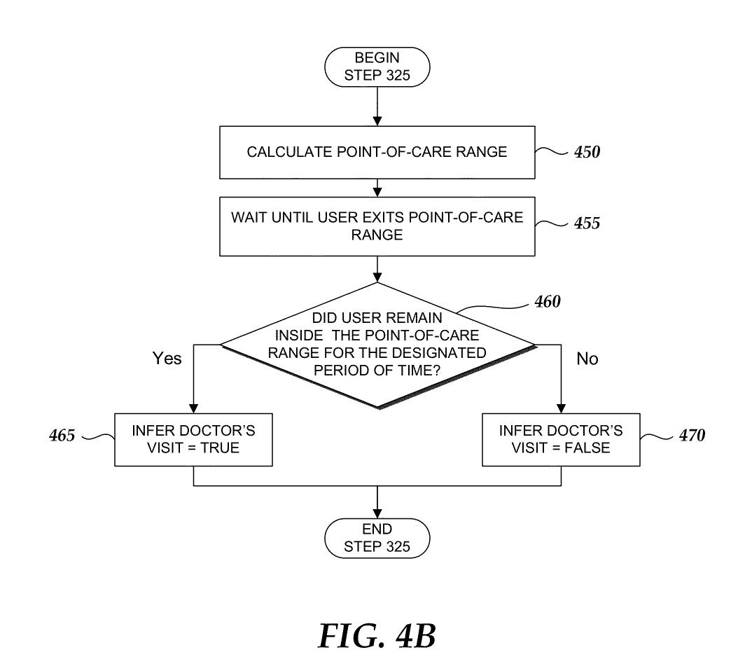

At step 320 a set of heuristics are used to infer if a doctor's visit has occurred. Two alternative embodiments of the processing performed at this step are provided hereinbelow with reference to FIGS. 4A-B. In certain embodiments, as discussed below with reference to FIGS. 4A-B, a designated time interval is passed in this step before processing resumes.

At step 325 if a doctor's visit was inferred in the previous step then processing flows to step 330; if no doctor's visit was inferred then processing returns to step 310.

At step 330 central server 130 issues an alert message to mobile device 110 that is typically displayed to the user, depending on whether the mobile device is switched on and any alert processing options the user may have selected. One example of an alert message is described with reference to FIG. 2 hereinabove. The alert message enables the user to indicate, for example by swiping or touching the message, if he/she wants to continue to place an order for a prescription using mobile application 115 that was prescribed by a doctor.

At step 335, if the user indicates that he/she wants to place an order for a prescription then processing continues at step 340 of FIG. 3B. If the user doesn't want to place an order than processing resumes at step 310.

Reference is now made to FIG. 3B. At step 340 a determination is made as to whether the prescription the user wishes to fill is in paper format or is electronic. If the prescription is in paper format then processing continues at step 345; if not, then processing continues at step 350.

At step 345 the user is prompted to scan the paper prescription into electronic format and is lead through a series of steps to perform the scanning operation. Processing then continues at step 355.

At step 350 the user is prompted to select a pharmacy to fulfill the prescription. Processing then continues at step 355.

At step 355 the user is prompted to select the name of the prescribing doctor. In one embodiment, the name of the prescribing doctor is saved to a list of favorite or preferred doctors that is stored locally by mobile application 115. The list of preferred doctors is subsequently which presented to the user when he/she is prompted to select the name of a prescribing doctor at step 355.

At step 360 the user is prompted to scan their insurance card if it hasn't already been scanned or otherwise provided.

At step 365 the user can view and edit the details of the order. In addition, the user can request whether they want to receive a phone call as confirmation prior to placing the order.

At step 370 the prescription is submitted electronically to the selected pharmacy. The details of the processing performed by the selected pharmacy are outside the scope of this invention.

### Inferring a Doctor's Visit

In certain embodiments, to determine if the user is paying a visit to a prescribing doctor, as required by step 325 of FIG. 3A, central server 130 makes an educated guess based on a set of heuristics that are implemented as a number of rules. The key steps in the method are to, (1) estimate the geographic area that contains the doctor's office, and (2) estimate the duration of a typical office visit.

To estimate the geographic area that contains the doctor's office, central server 130 searches one or both of commercial prescriber database 140 and prescriber database 135 for locations of doctors that match the most recently reported location of mobile device 110. Central server 130 obtains the number of employees at the matching doctor's office from prescriber database 135. Using the number of employees, central server 130 estimates the area and location of the facility in which the doctor provides care to patients, referred to as a point-of-care-range. The point-of-care range factors in that during a user's visit a user may spend time in a reception area, waiting room, bathroom, etc. In one embodiment, the area is estimated using a set of rules that specify a radius to apply in determining a point-of-care range, as given in Table 2, below:

TABLE 2
Rules For Determining Point-Of-Care-Location Radius

| # Employees | Radius |
|---|---|
| at a Location | (in feet) |
| 1-5 | 500 |
| 6-10 | 700 |
| 11-50 | 1000 |
| >50 | 2000 |

FIGS. 4A-B provide two methods for performing step 325 of FIG. 3A. Variants and combinations of these two methods are also within the scope of the subject invention.

Referring now to FIG. 4A, at step 405, central server 130 calculates a point-of-care range for the point-of-care-location, e.g. doctor's office, that matches the most recently reported location of mobile device 110.

At step 410 central server 130 estimates the visit time of the user as part of a doctor visit. This estimate includes the time spent from when the user reaches the point-of-care range to when they exit from the point-of-care range; i.e. it includes waiting time and the time actually spent with the doctor. In one embodiment, the estimate is based on a number of factors, given below in Table 3:

TABLE 3
Factors used to estimate time spent at point-of-care location by user

| Name of Factor | Description |
|---|---|
| WaitTime | The average wait time to see a doctor (typically, 10-30 |
| | min) |
| DoctorVisit | The average length of time spent with a doctor |
| | during a visit (typically, 15-20 min) |
| CF1 | A correction factor (CF) for the specialty of the doctors |
| | at the point-of-care facility. |
| CF2 | A correction factor (CF) for the average volume of |
| | prescriptions written by doctors at the location. For |
| | example, this may be represented as value from 1 to |
| | 10 that represents the relative volume of prescriptions |
| | made compared to the volume made at other locations. |
| CF3 | A correction factor (CF) for the day of the week when |
| | the visit is made. |
| CF4 | A correction factor (CF) for the time of the day when |
| | the visit is made. |

In one embodiment the estimated visit time is given as: Visit Time=(WaitTime+DoctorVisit)×CF1×CF2×CF3×CF4

Initial data for the various factors is based on available statistics. However, over time the subject invention may improve its estimates based updated data collected and based on user feedback.

At step 415, central server 130 waits until the estimated visit time elapses, or until the user exits the point-of-care range, whichever occurs first. Otherwise put, the central server 415 makes a determination as to whether the user has remained within the point-of-care range continuously for the duration of the estimated visit time.

If the user remains within the point-of-care range at least until expiration of the estimated visit time, then, at step 420, central server 130 infers that a doctor's visit occurred. If the user leaves the point-of-care range prior to expiration of the estimated visit time then, at step 425 no doctor's visit is inferred.

FIG. 4B provides another method for inferring if a doctor's visit occurred. At step 450, as with the method of FIG. 4A, central server 130 calculates a point-of-care range for the point-of-care location, e.g. doctor's office, that matches the most recently reported location of mobile device 110.

At step 455, central server 130 monitors the user's location to determine when he/she exits the point-of-care range and notes the time of exit.

At step 460 a determination is made as to whether the user remained inside the point-of-care range for a designated period of time. If so then at step 465 a doctor's visit is inferred; if not, then at step 470 a doctor's visit is not inferred.

It may be appreciated by one skilled in the art that whereas the steps of inferring a doctor's visit are performed by central server 130 in the embodiments discussed with reference to FIGS. 4A-B, in other embodiments these steps may be performed by mobile application 115.

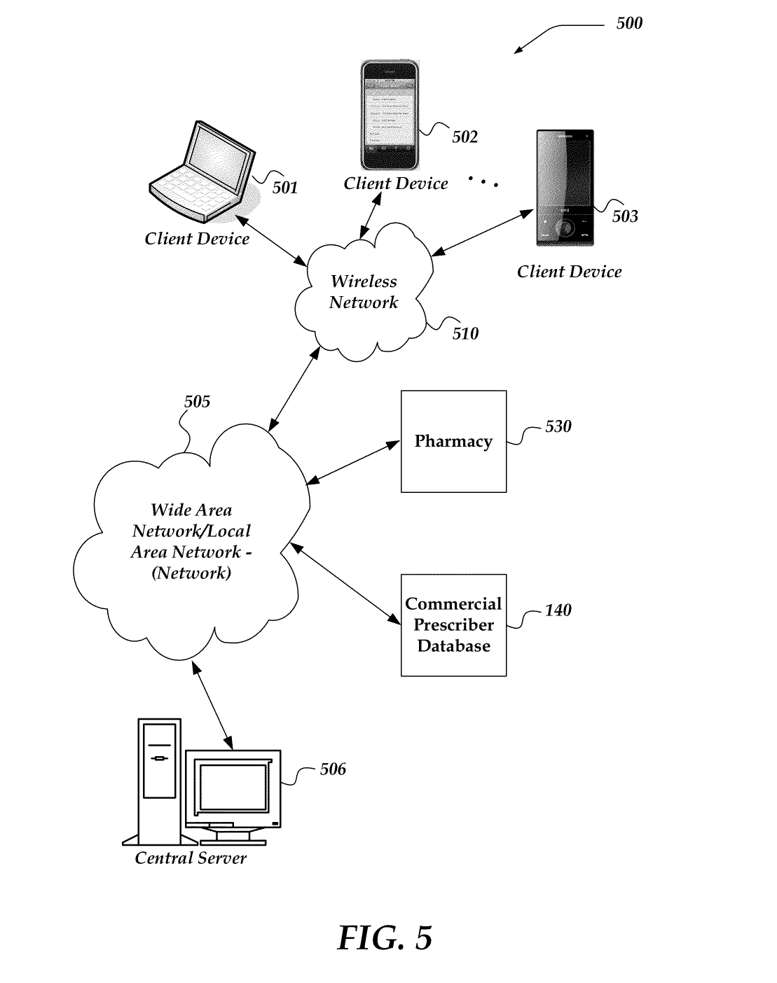

FIG. 5 is a system diagram that shows components of one exemplary environment in which the invention may be practiced. Not all of the components may be required to practice the invention, and variations in the arrangement and types of the components may be made without departing from the spirit or scope of the invention. As shown, system 500 of FIG. 5 includes wide area network (“WAN”)/local area network (“LAN”)−(network) 505, wireless network 510, client devices 501-503, and a central server 506.

Mobile device 110 is an embodiment of client devices 501-503 which typically connect to wireless network 510; although they may also, in certain cases, connect to network 505. Network 160 is an embodiment of wireless network 510, wide area/local area network 505, or a combination of both. Central server 506 shows one embodiment, or implementation, of central server 130.

Commercial prescriber database 140 is a network service and is depicted as being connected to network 505, but may also be connected to wireless network 510 or any other network. The implementation of commercial prescriber database is outside the scope of the present invention. Similarly, pharmacy 150 communicates over a network and is depicted as being connected to network 505, but may also be connected to wireless network 510 or any other network. The implementation of pharmacy 150 is outside the scope of the present invention.

Generally, client devices 501-503 include any computing devices that are capable of receiving and sending messages over a wireless network, such as wireless network 510 including smart phones and tablet computers, and the like. Client devices 501-503 include mobile devices such as mobile telephones, smart phones, display pagers, tablet computers, handheld computers, laptop computers, wearable computers, and also include personal computers, multiprocessor systems, microprocessor-based or programmable consumer electronics, or the like.

A Web-enabled client device can communicate across the Web. It may include a browser application that is configured to receive and to send web pages, web-based messages, or the like. The browser application may send, receive and display graphics, text, multimedia, or the like, employing a network protocol such as Hypertext Transfer Protocol (HTTP) and/or wireless application protocol (WAP).

Wireless network 510 is configured to couple client devices 501-503 with network 505. Wireless network 610 may include any of a variety of wireless networks that provide a connection for client devices 501-503. Such networks may include mesh networks, wireless LAN (WLAN) networks, cellular networks, or the like. Wireless network 510 may further include network devices such as gateways routers, or the like. In essence, wireless network 510 may include virtually any wireless communication device or mechanism by which enables information to travel between client devices 501-503 or another computing device, network, or the like.

Network 505 is configured to couple central server 506 with other computing devices, including through wireless network 510 to client devices 501-503. Network 505 may include the Internet in addition to local area networks (LANs), wide area networks (WANs), direct connections, combinations thereof or the like.

Central server 506 represents a network computing device that is configured to enable a user using client devices 501-503 to order prescriptions electronically from pharmacy 150. Central server 506 is one embodiment of a network device that implements prescription service 130.

Devices that may operate as central server 506 include, but are not limited to personal computers, desktop computers, multiprocessor systems, microprocessor-based or programmable consumer electronics, network PCs, servers, network appliances, and the like.

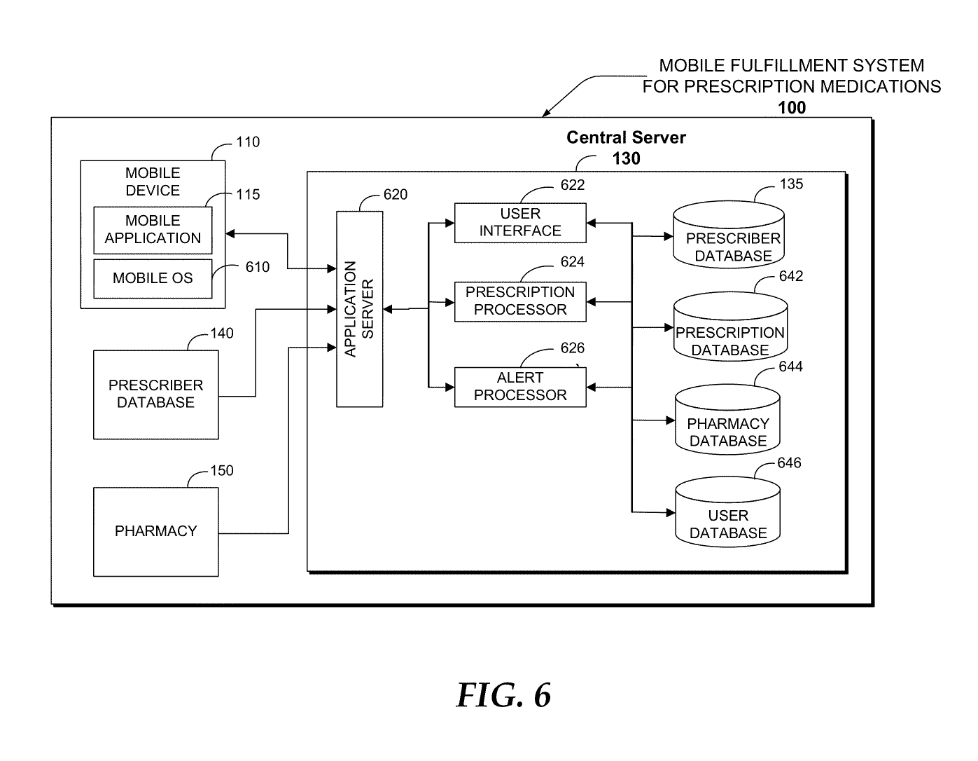

Although central server 506 is illustrated as a distinct network device, the invention is not so limited. For example, a plurality of network devices may be configured to perform the functions of central server 506. One such configuration is a “server farm” that includes multiple server computers operating cooperatively, each performing some of central server 506 server functions. One embodiment of the software modules that perform central server 506 server functions is described with reference to FIG. 6 below.

Central server 506 functions may also be provided by a cloud computing facility in which the services, features and functions ascribed herein to central server 506 are delivered as a service over a network, such as the Internet, rather than by a specific server or cluster of servers.

Central server 506 is capable of running application programs (“applications”). Applications that may be run by central server 506 include transcoders, database programs, customizable user programs, security applications, encryption programs, VPN programs, web servers, applications servers, account management systems, and so forth. Applications run by central server 506 may also include a user interface, a database manager, and other applications and processes such as those described below in conjunction with FIG. 6.

Central server 506 provides web services that provide content, including messages, over a network to another computing device. Thus, web services may include an application server, a web server, a messaging server, a File Transfer Protocol (FTP) server, a database server, a content server, or the like. Web services may provide the content including messages over the network using any of a variety of formats, including, but not limited to WAP, HDML, WML, SGML, HTML, XML, cHTML, xHTML, JSON, SOAP or the like. Web services may also include server-side scripting languages such as PHP, Python, and Java servlets. Web services may also include the server side of the Ajax web development method that enables a server to asynchronously respond to Ajax requests.

Central server 506 includes a computer processor (CPU), network interface card for communicating across network 505 and/or wireless network 510, and nonvolatile data storage for storing program code and data. Data storage may include virtually any mechanism usable for storing and managing data, including but not limited to a file, a folder, a document, a web page or an application, such as a database, digital media including digital images and digital video clips, and the like.

Data storage may further include a plurality of different data stores. For example, data storage may represent an opportunity database, a user database and other databases such as those described below in conjunction with FIG. 6. Further, data storage may also include network storage or cloud storage in which the physical storage media is accessed across a network.

FIG. 6 is a block diagram of the exemplary software modules of central server 130, used in mobile fulfillment system for prescription medications 100.

As discussed above with reference to FIG. 1, a customer interacts with mobile device 110 via mobile application 115. In a preferred embodiment, mobile application 115 is a native application that works in conjunction with a mobile operating system 610. For example, on Apple Computer's IPHONE mobile application 115 would use IOS. In another embodiment, mobile application 115 is a Web application, that is it is written using standard Web programming languages such as HTML, JAVASCRIPT, and JAVA, and is executed by a Web browser that runs in mobile device 115.

In one embodiment, mobile application 115 issues messages via mobile OS 610 and receives responses via mobile OS 610 from an application server 620 running in central server 130.

Application server 620 receives requests from mobile application 115 and invokes the appropriate central server 130 software module to process the request. Application server 620 may be a commercially available application server that accepts and processes request messages and transmits response messages back along with optional data contents, which may be web pages such as HTML documents, media objects such images and the like.

In one embodiment, central server 506 includes the following modules: a user interface 622, a prescription processor 624, and an alert processor 626. Central server 130 further includes four operational databases: prescriber database 135, a prescription database 642, a pharmacy database 644, a user database 646, and a results database 648. It may be appreciated that each of the abovementioned databases may be implemented as one or more computer files spread across one or more physical storage mechanisms. In one embodiment, each of the abovementioned databases is implemented as one or more relational databases and is accessed using the structured query language (SQL).

User interface 622, prescription processor 624, and alert processor 626 may each include, or may share the use of, a commercial database management system (DBMS) to access and search for data and objects that reside in the database. In a preferred embodiment, the DBMS is a relational DBMS (RDBMS) such as ORACLE® from the Oracle Corporation, SQL SERVER from the Microsoft Corporation, or the like.

User interface 622 receives data from mobile application 115 processes it and returns results. User interface 622 provides “back-end” processing that enables a user to sign up with central server 130, select preferred doctors, find doctors, find pharmacies, place an order for a prescription.

Prescription processor 624 tracks prescriptions and stores historical information concerning prescriptions in prescriber database 135.

Alert processor 626 performs steps 320 to 335 of the method of FIG. 3A. It receives a location message from mobile device 110 and determines if the mobile device is in a point-of-care location and if so it determines if a doctor's visit has been made by the user. If a doctor's visit is inferred then alert processor issues an alert to mobile device 110. Typically, a notification service provided by mobile OS 610 processes the alert and generates a visible and/or audio alert. For example, on Apple Computer's IPHONE, the Apple Notification Service is used. This allows the alert to be received and displayed to the user even if mobile application 115 is not active.

In the discussion hereinbelow concerning databases it may be appreciated by one skilled in the art that each database may be implemented as one or more database files, alternatively two or more of the databases may be implemented as a single database file. Further the term database may refer to a relational database file that is accessed by a relational database manager or it may implemented as a B-tree, R-tree, spreadsheet, flat file, comma separated value any other type of suitable data structure stored within one or more computer files.

Prescriber database 135 stores records for selected doctors, typically doctors in the local area. Prescriber database 135 is accessed when ordering a prescription. Prescriber database 135 identifies the user's preferred doctors. Prescriber database 135 may also include historical information for each prescriber such as waiting and visit times.

In certain embodiments, prescription database 642 stores records for prescription made by the user. The records typically include metadata that describe properties of each prescription such as the prescribing doctor, the pharmacy that fulfilled the prescription and the prescription itself.

Pharmacy database 644 stores records for select pharmacies.

User database 646 stores information for the user. This includes information such as name and contact information, username and password. It also includes information necessary to order a prescription such as method of payment and preferred delivery. In addition, user database 646 may store information about the user's preferences.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for electronic ordering of medicine, comprising:
maintaining a database of doctors that includes records for doctors, said records including a point-of-care location where a doctor provides care to patients;
receiving from a mobile device a location of the mobile device at a designated time;
determining that the location of the mobile device at the designated time matches a point-of-care location for a doctor included in the database of doctors;
inferring that the user of the mobile device has visited the doctor; and
sending an alert message to the mobile device;
wherein the method is implemented by a server computer.

2. The method of claim 1 further comprising
enabling the user of the mobile device to electronically place an order for a prescription made by the doctor during the visit to the doctor.

3. The method of claim 1 wherein inferring that the user of the mobile device has visited the doctor comprises estimating the time typically spent by a user at the facility in which the doctor provides care.

4. The method of claim 3 wherein estimating the time typically spent by a user at facility in which the doctor provides care is based on the sum of an estimate of the time spent by the user waiting for the doctor and an estimate of the time spent by the user with the doctor.

5. The method of claim 4 wherein estimating the time typically spent by a user at facility is further based on at least one correction factor, wherein a correction factor is selected from the group consisting of the specialty of at least one doctor at the facility in which the doctor provides care, the volume of prescriptions written by at least one doctor at the facility in which the doctor provides care, the day of the week, and the time of day.

6. The method of claim 3 further comprising calculating a point-of-care range, wherein said point-of-care range is an estimate of the size of the facility in which the doctor provides care, and said inferring that the user of the mobile device has visited the doctor comprises determining that the user has remained inside the point-of-care range at least the estimated time.

7. The method of claim 6 further comprising waiting the estimated time prior to sending the alert message.

8. The method of claim 1 further comprising calculating a point-of-care range, wherein said point-of-care range is an estimate of the size of the facility in which the doctor provides care, and said inferring that the user of the mobile device has visited the doctor comprises determining that the user has remained inside the point-of-care range for a designated period of time, at least the estimated time further comprising waiting the designated time prior to sending the alert message.

9. A server computer, comprising:
a processor;
a network interface card in communication with the processor;
a data storage for maintaining a database of doctors that includes records for doctors, said records including a point-of-care location where a doctor provides care to patients; and
a memory in communication with the processor for storing instructions, which when executed by the processor, cause the server:
to receive from a mobile device a location of the mobile device at a designated time;
to determine that the location of the mobile device at the designated time matches a point-of-care location for a doctor included in the database of doctors;
to infer that the user of the mobile device has visited the doctor; and
to send an alert message to the mobile device.

10. The server computer of claim 9 wherein said instructions further cause the server to enable the user of the mobile device to electronically place an order for a prescription made by the doctor during the visit to the doctor.

11. The server computer of claim 9 wherein inferring that the user of the mobile device has visited the doctor comprises estimating the time typically spent by a user at the facility in which the doctor provides care.

12. The server computer of claim 11 wherein estimating the time typically spent by a user at facility in which the doctor provides care is based on the sum of an estimate of the time spent by the user waiting for the doctor and an estimate of the time spent by the user with the doctor.

13. The server computer of claim 12 wherein estimating the time typically spent by a user at facility is further based on at least one correction factor, wherein a correction factor is selected from the group consisting of the specialty of at least one doctor at the facility in which the doctor provides care, the volume of prescriptions written by at least one doctor at the facility in which the doctor provides care, the day of the week, and the time of day.

14. The server computer of claim 11 wherein said instructions further cause the server to calculate a point-of-care range, wherein said point-of-care range is an estimate of the size of the facility in which the doctor provides care, and said inferring that the user of the mobile device has visited the doctor comprises determining that the user has remained inside the point-of-care range at least the estimated time.

15. The server computer of claim 14 wherein said instructions further cause the server to wait the estimated time prior to sending the alert message.

16. The server computer of claim 9 wherein said instructions further cause the server to calculate a point-of-care range, wherein said point-of-care range is an estimate of the size of the facility in which the doctor provides care, and said inferring that the user of the mobile device has visited the doctor comprises determining that the user has remained inside the point-of-care range for a designated period of time, at least the estimated time further comprising waiting the designated time prior to sending the alert message.
